(19) United States
(12) Patent Application Publication
(10) Pub. No.: US 2014/0164286 A1
(43) Pub. Date: Jun. 12, 2014

(54) Interest Rate Swap Risk Compression

(71) Applicant: CHICAGO MERCANTILE EXCHANGE INC., Chicago, IL (US)

(72) Inventors: Udesh Jha, Chicago, IL (US); Sasha Rozenberg, New York, NY (US); Ziyi Wang, Chicago, IL (US); Jalpan Shah, Chicago, IL (US)

(73) Assignee: CHICAGO MERCANTILE EXCHANGE INC., Chicago, IL (US)

(21) Appl. No.: 13/711,390

(22) Filed: Dec. 11, 2012

(51) Int. Cl. G06Q 40/06

(52) U.S. Cl. CPC G06Q 40/06
USPC 705/36 R

(57) ABSTRACT

The disclosed embodiments relate to minimization of risk of loss, and thereby minimization of margin and/or guarantee fund requirements, for a portfolio of interest rate swap (“IRS”) positions held by a market participant. The disclosed embodiments identify proposed trades across portfolios wherein execution of the proposed trade would result in a reduction of the risk of loss of the portfolio and the other portfolio, by iteratively testing each of a set of candidate trades between substantially equivalent positions in the portfolio and other portfolio for an effect on the risk of loss of the portfolio, the identified proposed trade comprising a candidate trade which results in a reduction in risk of loss of the portfolio in excess of a threshold. The disclosed embodiments then provide each of the identified proposed trades to at least the market participant who holds the subject portfolio for acceptance thereby.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House for itself, referred to as production trades, or on behalf of their customers.

An interest rate futures contract, also referred to as an interest rate future, is a futures contract having an underlying instrument/asset that pays interest, for which the parties to the contract are a buyer and a seller agreeing to the future delivery of the interest bearing asset, or a contractually specified substitute. Such a futures contract permits a buyer and seller to lock in the price, or in more general terms, the interest rate exposure, of the interest-bearing asset for a future date.

An interest rate swap (“IRS”) is a contractual agreement between two parties, i.e., the counterparties, also referred to as the payer and receiver, where one stream of future interest payments is exchanged for another, e.g., a stream of fixed interest rate payments in exchange for a stream of floating interest rate payments, based on a specified principal amount. An IRS may be used to limit or manage exposure to fluctuations in interest rates. One common form of IRS exchanges a stream of floating interest rate payments on the basis of the 3-month London interbank offered rate for a stream of fixed-rate payments on the basis of the swap's fixed interest rate. Another common form of IRS, known as an overnight index swap, exchanges, at its termination, a floating rate payment determined by daily compounding of a sequence of floating interest rates on the basis of an overnight interest rate reference (e.g., the US daily effective federal funds rate, or the European Overnight Index Average (EONIA)) over the life of the swap, for a fixed rate payment on the basis of daily compounding of the overnight index swap's fixed interest rate over the life of the swap.

An interest rate swap futures contract is one in which the underlying instrument is an interest rate swap. As such, an interest rate swap futures contract permits “synthetic” exposure to the underlying interest rate swap, i.e., without entailing actual ownership of the underlying IRS.

In a typical futures trading environment, the standardization of futures contracts and the nature of the central counterparty based trading system allows an Exchange, or market participant thereof, to net together offsetting positions in the same contract for the purpose of reducing the margin requirement to reflect the reduced risk of loss of such positions and/or to outright consolidate positions to reduce the size of the portfolio and/or reduce transaction fees therefore. As the Exchange, being a central counterparty to all transactions, ensures that each counter-party is not at risk of loss due to the default of the other party, such netting and consolidation by one market participant does not affect the positions and risk undertaken by another participant. Furthermore, identifying qualifying futures positions which may be netted is well known and generally can be performed with respect to a single portfolio without affecting other portfolios as positions in futures contracts, once entered into by a market participant, i.e. subsequent to the trade, are substantially independent from the counter-position thereto, i.e. the netting of positions in one portfolio does not affect, nor is based on, positions in another portfolio.

In the case of IRS contracts, however, the variability in the characteristics of positions which may exist in any given portfolio, such as the maturity date, coupon, etc., makes it difficult to identify suitable positions for netting though, for example, such positions, though not identical, may exist which are similar enough as to represent a reduced risk of loss meriting a reduction in the margin requirement. Further complicating this process is the bilateral nature of an IRS contract where a particular position of one party is coupled with a counter position of a counter-party thereto. Further, as described above, positions in IRS contracts, and in particular, various combinations of positions therein, are typically undertaken to serve particular economic purposes, such as to achieve a particular risk exposure or risk profile, which may be unique to that market participant. In addition, the nature of an IRS contract, e.g. being based on a floating interest rate, complicates the assessment of the risk of loss, and the corresponding margin requirement, further complicates identification of transactions which may reduce the risk of loss, and thereby, the margin requirement. Accordingly, IRS contract positions within a particular portfolio may not be consolidated as suitable offsetting transactions may not be readily identified or without necessarily affecting not only the economic purpose intended by the market participant holding that portfolio but also the economic purposes, which may be different, of any counter party market participants thereto. Accordingly, opportunities to reduce margin requirements and/or guaranty fund contributions for IRS contract portfolios may be limited.

### BRIEF DESCRIPTION OF THE DRAWINGS

FIG. 1 depicts an illustrative computer network system that may be used to implement aspects of the disclosed embodiments.

FIG. 2 depicts a block diagram of an exemplary implementation of the system of FIG. 1 for minimizing risk of loss of a portfolio of IRS positions.

FIG. 3 depicts a flow chart showing operation of the system of FIGS. 1 and 2.

FIG. 4 shows an illustrative embodiment of a general computer system for use with the system of FIGS. 1 and 2.

FIG. 5 depicts a flow chart showing more detailed operation of the system of FIG. 2.

FIG. 6 depicts a flow chart showing more detailed operation of the system of FIG. 2.

FIG. 7 shows an exemplary risk grid generated by the system of FIG. 2 according to one embodiment with initial seed values.

FIG. 8 shows an exemplary grid depicting hedge ratio trade pairs.

FIGS. 9A and 9B show an exemplary results of the operation of the system of FIG. 2 to match trades and recompute a margin therefore.

FIG. 10 shows an exemplary grid of trade matching results according the system of FIG. 2

### DETAILED DESCRIPTION

The disclosed embodiments relate to minimization of risk of loss, and thereby minimization of margin and/or guarantee fund requirements, for a portfolio of interest rate swap (“IRS”) positions held by a market participant. The disclosed embodiments identify, for each of one or more of the IRS positions in the portfolio, a counter-position in another portfolio held by another market participant, and not accessible by the market participant, for a proposed trade therewith wherein execution of the proposed trade would result in a reduction of the risk of loss of the portfolio and the other portfolio, by iteratively testing each of a set of candidate trades between substantially equivalent positions in the portfolio and other portfolio for an effect on the risk of loss of the portfolio, the identified proposed trade comprising a candidate trade which results in a reduction in risk of loss of the portfolio in excess of a threshold. The disclosed embodiments then provide each of the identified proposed trades to at least the market participant who holds the subject portfolio for acceptance wherein neither the market participant or the other market participant of each proposed trade know the identity of each other.

Generally, the disclosed embodiments relate to a system and/or method to reduce a margin, initial and/or maintenance, and, in at least one embodiment, guaranty fund, requirements by identifying trades within interest rate swap portfolios that significantly compress the risk exposure to the central clearing counterparty, i.e. the risk of loss. A guaranty fund is a fund to which each Clearing Member contributes and/or pays assessments and which may be used to cover losses incurred by the Clearing House due to a defaulted portfolio if the defaulted Clearing Member's assets, including amounts available pursuant to any guarantee from an Affiliate of a Clearing Member, available to the Clearing House are insufficient to cover such loss, regardless of the cause of default. The guaranty fund, to which all clearing members are required to contribute, is utilized to cover extreme loss scenarios that are optimally addressed using a mutualized pool of funds rather than individual margin account funds. Refer to “CME Rulebook: Chapter 8G. Interest Rate Derivative Clearing: Rule 8G07. IRS FINANCIAL SAFEGUARDS AND GUARANTY FUND DEPOSIT”.

In particular, the disclosed embodiments search for optimal trade pairs between the clearing members' production IRS portfolios with a criteria of margin and guaranty fund reduction. Clearing members may also be referred to as dealers. A “cleared house IRS portfolio” is the portfolio comprising positions undertaken by the clearing member on its own behalf as opposed to the one or more portfolios maintained thereby on behalf of other market participants, such as the customers of the clearing member. A “production portfolio” may refer to a cleared house portfolio cleared by a central counterparty such as the CME clearing. The disclosed embodiments will be described with reference to risk reductions, and associated margin and/or guaranty fund contribution reductions, of clearing member, aka dealers, as these parties are typically concerned with minimizing risk and minimizing capital requirements associated with margin and guaranty fund contributions. While the disclosed embodiments may also be applicable to other traders, such traders may have other considerations, as were described above, e.g. economic purposes or motivations, with respect to desired risk wherein minimal risk may, in fact, not be considered optimal as opposed to these other considerations. As such, the disclosed embodiments, may not be utilized with respect to portfolios of such market participants who have goals other than to minimize risk and associated margin requirements. It will be appreciated that, in at least one implementation, the operation of the disclosed embodiments results in the presentation of potential trades to the respective market participant for them to accept or decline and, as such, the disclosed embodiments may be utilized with any market participant, wherein those market participants whose goal is other than minimal risk are free to decline or otherwise ignore the proposed trades.

The system operates automatically to identify proposed trades and present those trades to the respective clearing members to accept or decline. The main risk measure is DV01, also referred to as price sensitivity. The result of adding the optimized trade pairs to existing clearing members' portfolios introduce a reduction in DV01 risk, thus changing the original risk profile of the portfolio. DV01 risk is the dollar amount that would be gained or lost by a one basis point change in the yield curve/interest rate, or the ratio of a price change in output (dollars) to unit change in input (a basis point of yield).

As described above, the disclosed embodiments may identify risk offset opportunities amongst dealers' over the counter (“OTC”) IRS portfolios by identifying trades between market participant, e.g. clearing member, counterparties that reduce clearing costs or otherwise result in reduction in the risk of loss. The cost reduction may include reductions of initial margin, maintenance margin and/or guaranty fund contributions. As OTC IRS markets move to a centrally-cleared environment, the clearing house, such as CME Clearing, is in a unique position by having access to direct trade information of all clearing member's portfolios. In a centrally cleared market, the market participants may not be aware of the counter parties to their transactions due to the mechanism of central clearing wherein the clearing house novates itself into the transaction to act as a guarantor. A central clearing house, e.g. CME Clearing, is in a natural position to provide trade matching service that creates capital saving for dealers while mitigating market risk amongst clearing members.

The disclosed embodiments search for IRS trade opportunities that maximize margin savings relying on the clearing members' trade portfolio data. The disclosed embodiments may search across all portfolios, or a subset thereof, for all potential trades that result in a margin reduction, or a subset thereof. In one embodiment, the system may then filter those potential trades such that, for example, only margin reductions which exceed a defined threshold, which may be set by the central clearing house, the market participant or a combination thereof, are further considered. In an alternate embodiment, any trade which results in any amount of margin reduction may be further considered. If a potential trade is found that reduces margin, e.g. by a defined threshold, that trade is then communicated to the relevant clearing members for possible execution.

The disclosed trade search engine may be optimized to identify trades that would result in margin and/or guaranty fund reduction for both parties or just one party to the trade. In alternate embodiments, trades which result in asymmetric margin reductions or which benefit only one counter party may be generated and proposed. The trade search engine relies on a measure of risk of each portfolio called Delta Risk, i.e. DV01, which is the ratio of the change in price of the underlying asset to a change in the price of the derivative thereof, also referred to as the price sensitivity to a change in the underlying price.

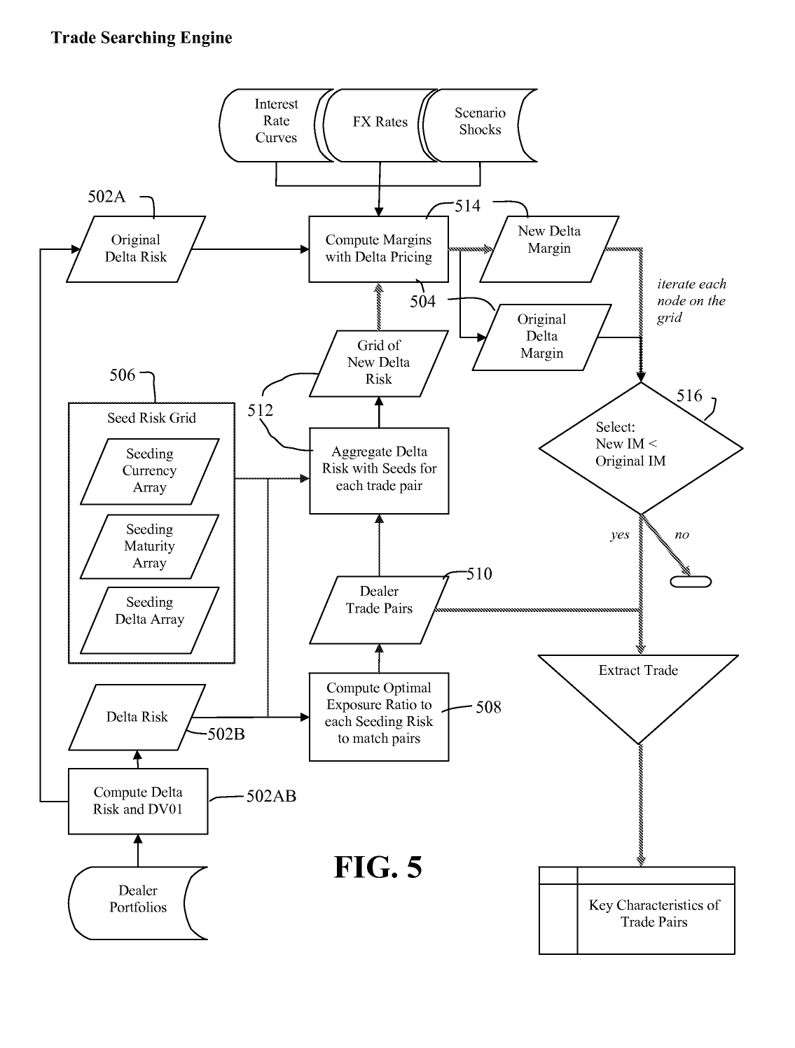

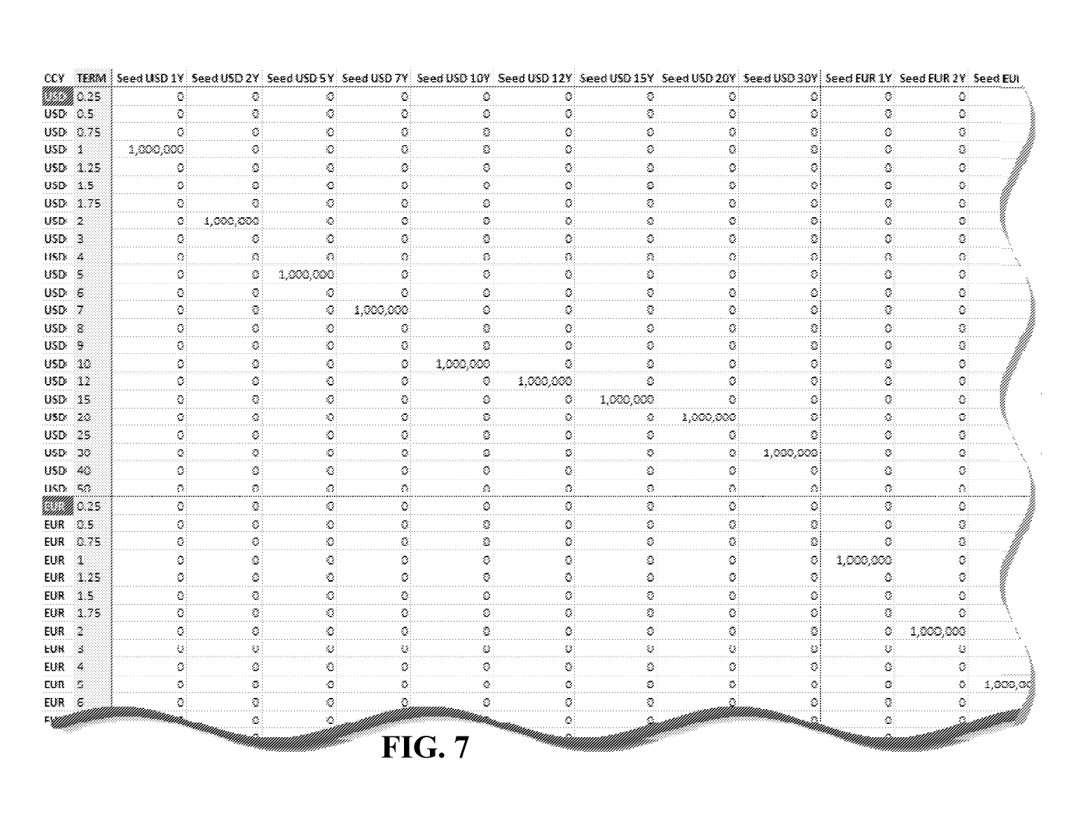

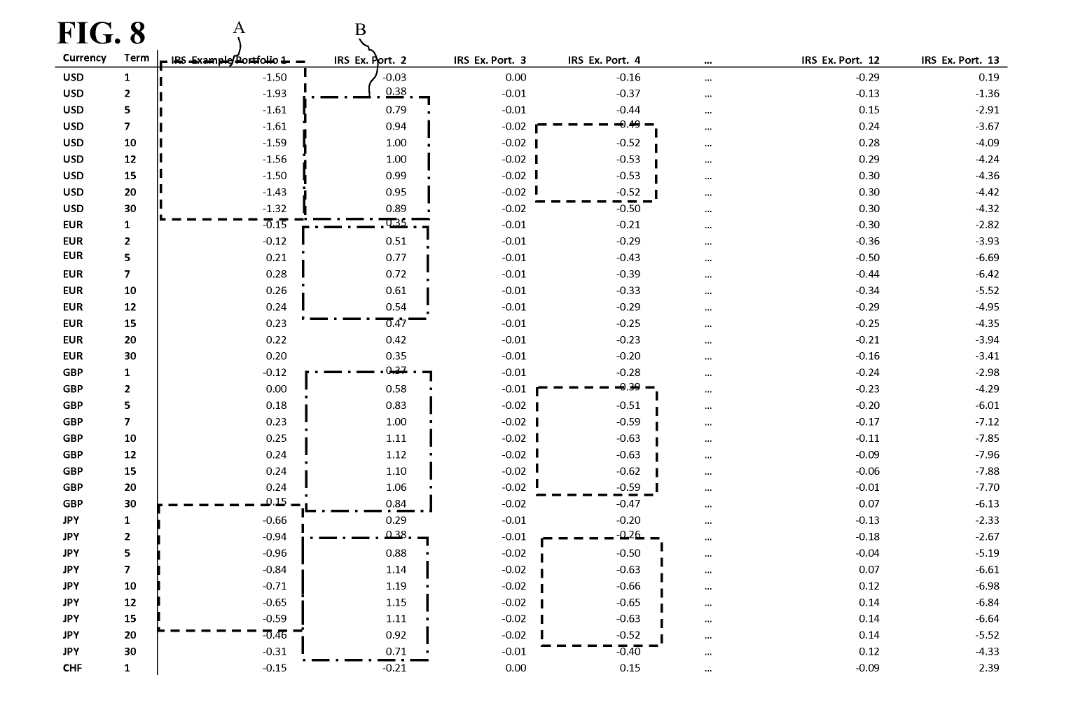

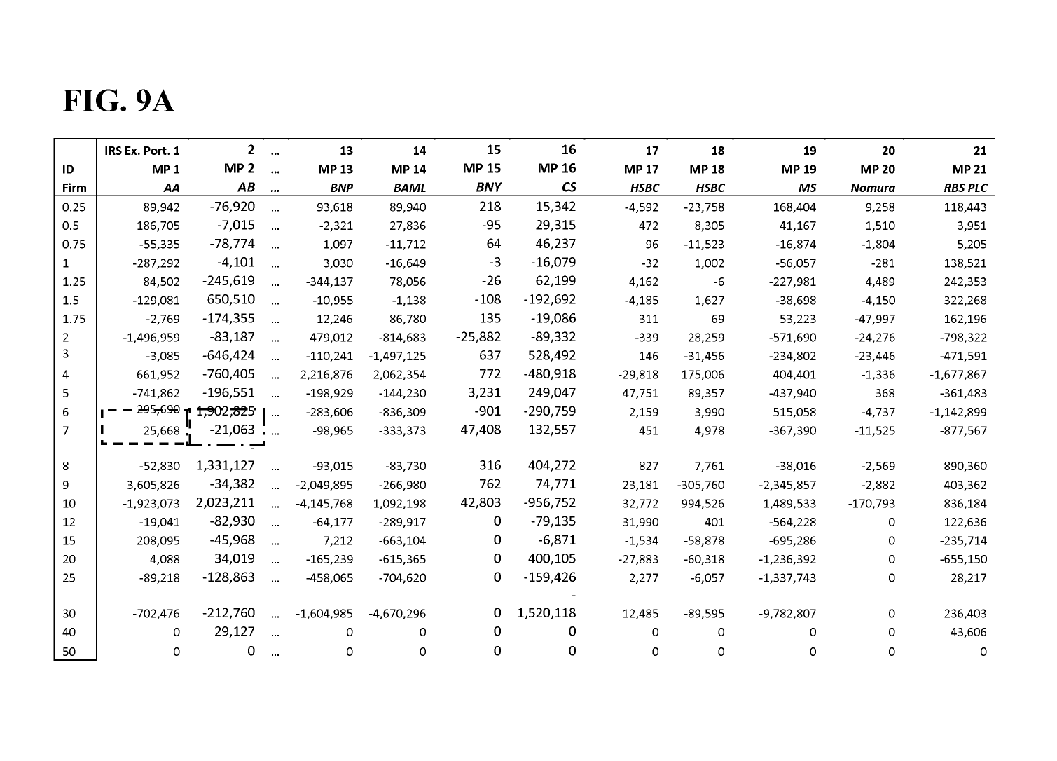

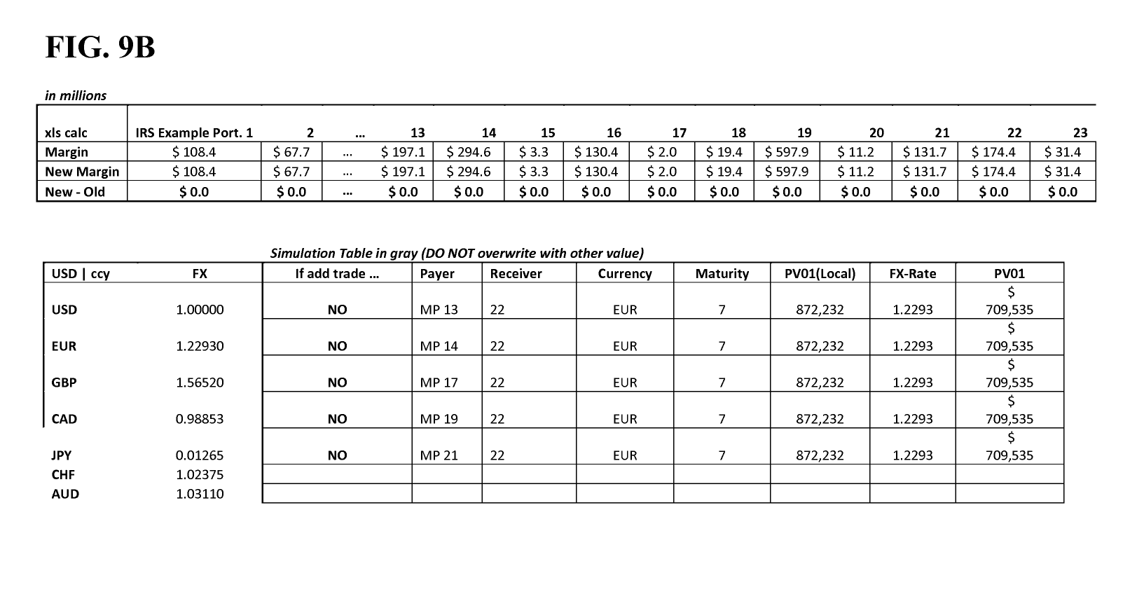

Generally, as shown in FIG. 5, the disclosed embodiments:
1. Calculate the Delta Risk for each clearing member's portfolio given a set of key tenor points for each instrument for which a position is held in the portfolio, i.e. time to maturity along a yield curve where the instrument is most liquid, e.g. the times when traders most want to trade the instrument (Block 502A). See, for example FIG. 7 which shows an exemplary risk grid wherein each row represents a key rate term for one currency and each column represents a candidate trade with seeding DV01 of $1 mm at the corresponding key rate term point. Tenor points may be specified as years or fractions thereof. Delta Risk is calculated by applying a 1 basis point (“bps”) change to each tenor point along a rate curve, and then determining the difference in net present value (“NPV”) of the portfolio based on that change.
2. Calculate a number of Profit & Loss (“P&L”) scenarios for each clearing member's production portfolio (Block 504). In one embodiment, 1260 scenarios (based on the number of business days in the past 5 years) are calculated, however the number of scenarios can be increased or decreased based on risk measurement accuracy. The P&Ls are intermediate outputs in the IRS Historical Value at Risk (“HVaR”) margin methodology, a known methodology, implemented as a computer program/tool, which measures the potential loss in value of an individual asset or a portfolio over a defined period of time for a given confidence interval and which may be utilized to compute margin requirements for interest rate swaps. This step may utilize delta pricing approximation, computed by multiplying the delta by the rate movement, to improve the computation performance.
3. Pre-determine the Delta Risk seeding value for candidate trades used in the trade matching optimization process utilizing linear regression (Block 506). In a preferred example, there are 63 candidate trades for seven typically traded currencies with $1M each as seeding Delta Risk. The typically traded currencies include US dollars, Euros, Pounds, Canadian dollars, Yen, Swiss Francs, and Australian dollars. It will be appreciated that other currencies may also be supported in lieu of or in addition to these seven currencies.
4. Calculate 1260 Profit and Loss (“P&L”) scenarios for each one of the candidate trades. The P&L scenarios are intermediate outputs in IRS HVaR margin methodology as in step 2, above (Block 502B).
5. Compute the optimal hedge ratio on each candidate trade for each dealer portfolio which minimizes the P&L scenario variance for the candidate trade, i.e. minimizes the dispersion of the distribution of the P&L scenarios for the candidate trade (Block 508). The hedge ratio is a scalar to rescale the candidate trade so that the minimum margin for a portfolio is achieved by adding this rescaled candidate trade into the portfolio. For each dealer's portfolio, there are a total of 63 hedge ratios associated to all candidate trades. A table of exemplary hedge ratios is shown in FIG. 8 wherein each row represents the candidate trade, detailed in FIG. 7, specified by currency and time-to-maturity (term) and each column represents one IRS portfolio, labeled “IRS Example Portfolio 1”, etc.
6. For each candidate trade, search the other clearing members' portfolios pair-wise to find the pairs with hedge ratios of opposite signs (Block 510). Each pair is associated with one candidate trade where the one with a positive hedge ratio is the payer side of a swap and the one with a negative hedge ratio is the receiver side of a swap. The candidate trade rescaled by the hedge ratio represents the risk that can potentially be compressed by this trade.
7. For each pair preserved from step 6, update Delta Risk on both parties to include the Delta Risk of the candidate trade (Block 512).
8. Re-calculate margin requirements using the delta pricing approximation method for each pair of the dealer portfolios given new Delta Risk (Block 514). If margins decrease for both parties and the amounts are above a threshold, then the trade is saved as a potential trade (Block 516). FIGS. 9A and 9B show an exemplary list of proposed trades wherein the table of FIG. 9A shows the delta risk for each portfolio, denoted by “IRS Ex. Port. 1”, etc., including the matched new trade's delta risk one pair at a time (denoted by the dotted line boxes), the top table of FIG. 9B shows the re-calculated margin values after including a matched new trade, and the bottom table of FIG. 9B shows a summary of the matched trades' characteristic, the original and new margin retained from iterations for one clearing member firm being evaluated.

Value at Risk (“VaR”) measures the potential loss in value of an individual asset or a portfolio over a defined period for a given confidence interval. For example, if the VaR on an asset is $5 mm for a 5 day, 95% confidence interval, the implication is that there is only a 5% chance that the value of that asset will drop by more than $5 mm over any consecutive 5 day period. VaR may be an essential metric for central clearing organizations, such as CME Clearing, in order to set the initial margins on the different futures contracts that it clears.

CME Clearing applies the HVaR model to determine initial margin levels for Eris interest rate swap futures as well as for cleared OTC interest rate swaps. The basic parameters (which may be changed) are:

Historical rates for the past 5 years (1260 business days)

Forecasted volatility floor of 17.5% (annualized)

99.7% confidence interval

Note that HVaR is also applied to Eurodollars and Treasury futures in portfolios for which margin offsets with Eris interest rate swap futures apply. Upon observing the historical rates, the model calculates a forecasted volatility for each tenor using an exponentially weighted moving average methodology which applies heavier weights to the recent 6 months of data in order to better capture current market conditions. Without using an exponentially weighted average, the historical VaR methodology would be in danger of not reacting quickly enough to volatile market environments. The model also uses a volatility floor of 17.5% as another protection against generating margin requirements that are too low to guard against sudden volatility spikes.

Using the forecasted volatilities, the model then calculates expected returns for each asset over the following 5 days. It then selects the margin as the maximum loss using a 99.7% confidence interval from the generated P/L distribution. CME Clearing arrived at a 99.7% confidence interval based on its out of sample back testing performed on more than 10,000 portfolios, as that confidence interval proved to be the number which led to a 99% aggregate coverage across those portfolios.

The HVaR model is more suitable for both Eris contracts and cleared OTC interest rates swaps than the SPAN methodology given their higher level of granularity in terms of daily maturities and multiple fixed rates than more traditional futures products that are limited to monthly and quarterly maturities.

In contrast to its implementation of SPAN, CME Clearing incorporates the margin output from the HVaR model on a daily basis. In this manner, the margin requirements reflect the real time risk profile of the position. Margin offsets between Eris contracts and highly correlated positions are also be calculated on a daily basis, as opposed to the current methodology for other cleared products, where CME Clearing publishes, on a less frequent basis, a set of offset-able combinations and their associated initial margin levels.

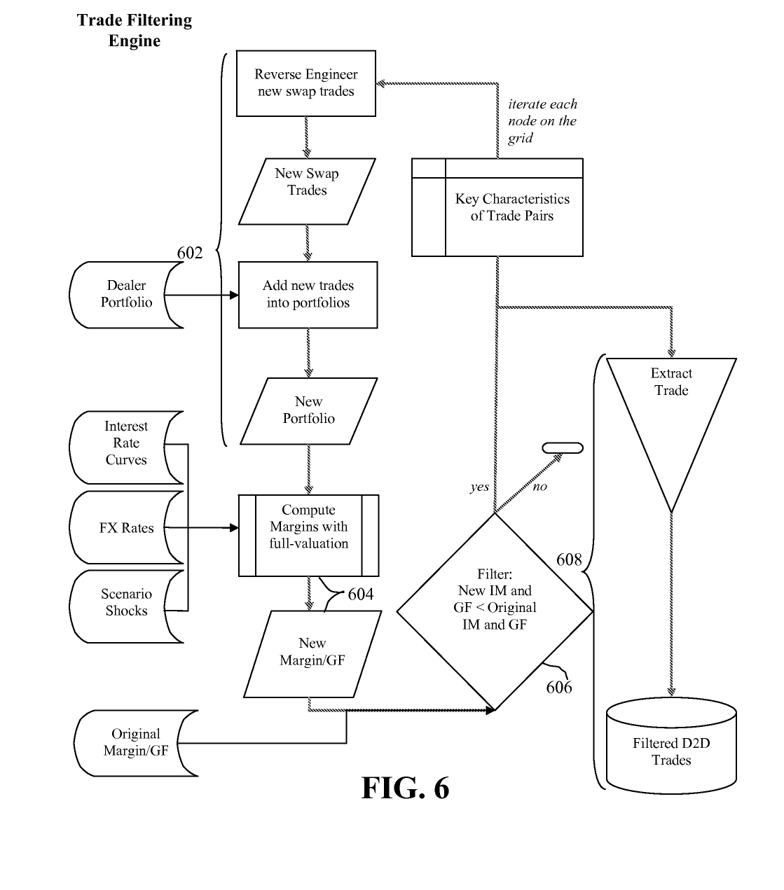

The disclosed embodiments may further include a trade filtering engine, described in more detail below, which is then used to identify the best proposed trade for communication to counterparties, as shown, for example, in FIG. 6. The steps taken by the trade filtering engine include:
1. Reverse engineer a new swap portfolio for each customer—the new portfolio will include the potential trades identified above by the trade search engine (Block 602);
2. Re-calculate the initial margins and guaranty fund requirements with a full-valuation method whereby the difference between a summation of the net present value (“NPV”) of the all of the floating interest rate cash flows and a summation of the NPV of all of the fixed interest rate cash flows of the IRS position (Block 604);
3. Filter the trades that decrease the margins for both parties by an amount above a certain threshold (e.g., $10 MM) (Block 606); and
4. Suggest each pair of filtered trades to the counterparties (Block 608).

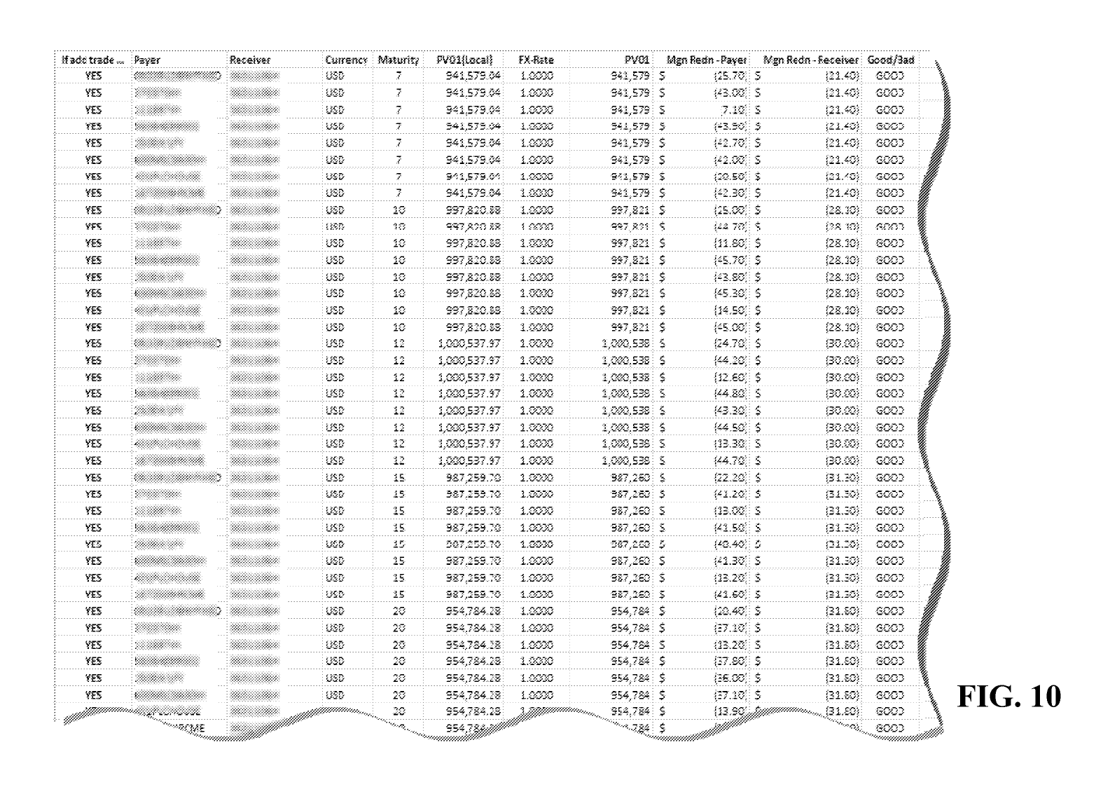

FIG. 10 shows a table depicting margin reduction for an exemplary portfolio according to the disclosed embodiments wherein each row is a matched trade and the columns include the characteristic of the trade, the counterparties involved and the estimated margins. The identities of the parties listed in the Table of FIG. 10 have been intentionally obfuscated.

The disclosed embodiments may advantageously improve the capital efficiency for IRS dealers and compress their risk exposure. In contrast, prior mechanisms for reducing risk, such as the Counterparty Risk Reduction Service offered by TriOptima AB, New York, N.Y., aim to reduce dealers' risk exposure but cannot further reduce capital costs or enhance capital efficiency as such systems do not have access, as does a central clearing organization, across portfolios to compute accurate margin and guarantee fund requirements and test the mutual effects of proposed trades thereon. Furthermore, as such services do not have portfolio access as does a central clearing organization, they are dependent upon the market participant's risk profile disclosure which may be inaccurate or lacking in sufficient detail and thereby inefficient to reduce the aggregate risk exposure.

In one exemplary implementation, the disclosed embodiments are implemented as an Interest Rate Swap Risk Compression Tool which is designed to search for risk offset opportunities amongst clearing members' IRS portfolios by identifying trades that reduce the clearing costs, including initial margin requirements, maintenance margin requirements and/or reductions of guaranty fund contributions. The unique benefit of a central clearing organization, such as CME, providing this service is that the suggested trades may be restricted to be margin and/or guaranty fund reducing. Unlike banks or other financial services entities, a central clearing organization, such as CME clearing, has the direct information of all clearing member's portfolios. This provides the central clearing organization, e.g. CME clearing, a natural position to provide a trade matching service that creates capital saving for clearing members while mitigating market risk amongst clearing members. The algorithm to search for the trade opportunities may have an objective function of maximizing margin saving amount given a threshold value.

In particular, the following steps may be used, such as by a trade searching engine, described in more detail below, to match trades for IRS portfolios:
Calculate the Delta Risk for each of the clearing member's portfolio given a set of key tenor points. Delta Risk is calculated by applying a 1 basis point (“bps”) change to each tenor point along a rate curve, and then determining the difference in net present value (“NPV”) based on that change
Calculate 5 years or 1260 profit and loss (“P&L”) scenarios for each clearing member portfolio. The P&L scenarios are intermediate outputs of the IRS HVaR margin methodology. This step may use delta pricing approximation to improve the computation performance.
Prepare a risk grid representing candidate trades' DV01. Candidate trades include all currencies launched by CME OTC IRS clearing service seeded with $1 million DV01 each. For each currency, there are 9 vanilla IRS trades used as the initial seeds representing risk across maturities from 1-year to 30-year. (FIG. 7)
For each clearing member portfolio, compute the optimal hedge ratio to each candidate trade. The hedge ratio is a scalar to rescale the candidate trade so that the minimum margin for a portfolio is achieved by adding this rescaled candidate trade into the portfolio. For each dealer's portfolio, there are a total of 63(=number of currency launched×number of vanilla candidate trades per currency) hedge ratios associated with candidate trades. For each candidate trade, there are multiple hedge ratios associated with each dealer's portfolio. (FIG. 8)
The optimal hedge ratio, i.e. the ratio between the fair value changes of the hedging instrument and the hedged item, is computed as follows. The objective is to solve for the DV01 of a candidate trade so that by adding this trade, the portfolio margin is minimized. Margin is defined as the Value-at-Risk (“VaR”) with 99.7% confidence interval, derived from rescaled historical scenario P&Ls:

Margin=VaR(α=99.7%)
It is well known that VaR can be expressed as the standard deviation multiplied by a constant

Margin=VaR(α=99.7%)=c·σ
So the objective can be transformed into minimizing the standard deviation of the historical scenario P&L distribution σ. Define the original portfolio scenario P&L vector as y, the candidate trade i scenario P&L vector as X_i and the optimal hedge ratio as β

$${argmin}_{β} \{ var ( y - β {X}_{i} ) \}$$

This is equivalent in solving a linear regression problem with ordinary least squares (“OLS”) estimation:

y=\hat{β}·Xᵢ+ε
For each candidate trade, search clearing members' portfolios pair-wise to find the pairs with hedge ratios of opposite signs. Each pair is associated with one candidate trade where the one with positive hedge ratio is the payer side of a swap and the one with negative hedge ratio is the receiver side of a swap. The risk that can potentially be compressed by this trade is the DV01 of the candidate trade rescaled by the hedge ratio.
As Interest Rate Swap has a linear risk, the P&L of the swap can be expressed as the inner product of DV01 (D_{X}) and interest rate movements (θ). Therefore, the scenario P&L Xᵢ of candidate trade and the scenario P&L y of the original portfolio can be written as

Xᵢ=(θ′·D_{X}) and y=(θ′·D_{y})
The regression problem can then be written as

D_{y}=\hat{β}·D_{X}+ε
This means that the hedge ratio β calculated can be directly used to rescale the seeding delta values to produce the corresponding trades.
Re-calculate margin requirements with delta-valuation method for the pair of dealers given new Delta Risk. If margin decreases for both parties above a threshold, save as a potential trade.
Repeat the above mentioned two steps for each pair of currency and each pair of key tenors to find out a potential trade list. (FIG. 9)

The following steps may be used, such as by a trade filtering engine, described in more detail below, to filter qualifying trades for IRS portfolios from the candidate trades identified by the prior process:
Reverse engineer new swap trades, i.e. to determine start date, end date, notional value and coupon value from the time to maturity, delta and payer/receive identities derived by the trade searching engine, and add these trades into corresponding portfolios. Re-calculating the margins with full-valuation method.
Filter the trades that decrease the margins and GF for both parties above certain threshold, such as $10 million dollars.
Suggest each pair of trades to the respective counterparties for acceptance thereby. (FIG. 10)

In one embodiment, the trade matching service meets the following goals:
Margin reduction: margin savings is the objective of the matching algorithm. All trades that are selected by the searching algorithm may be guaranteed to reduce both counterparties' current margins.
Guaranty fund contribution reduction: the reduction in risk exposure may lead to decrease in stress tests; this reduces the shortfall (under-collateralized risk) and, in turn reduces the guaranty fund size.
Risk balancing: since the objective function is to maximize margin reduction, IRS margin model directly addresses market risk of a portfolio. Thus each pair of trades reduces both clearing member's market risk exposure, as well as CME's exposure to both counterparties.

While the disclosed embodiments may be discussed in relation to IRS contracts, it will be appreciated that the disclosed embodiments may be applicable to other bilateral contracts, equity, options or futures trading system or market now available or later developed.

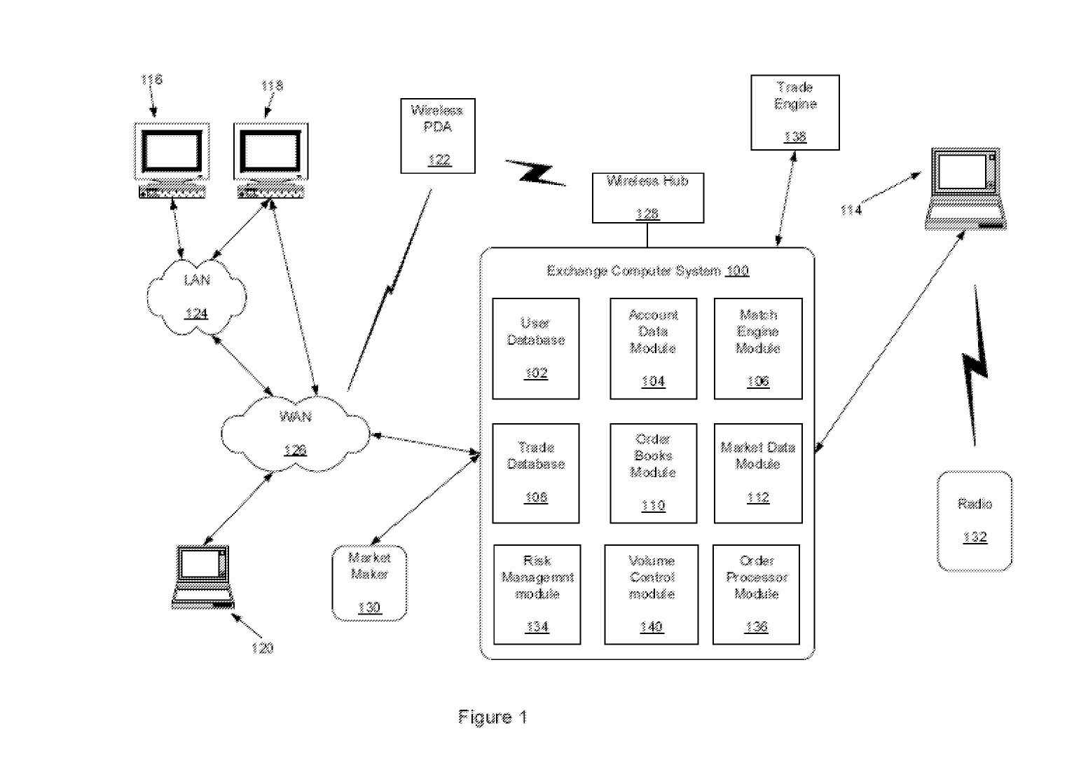

It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange. An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

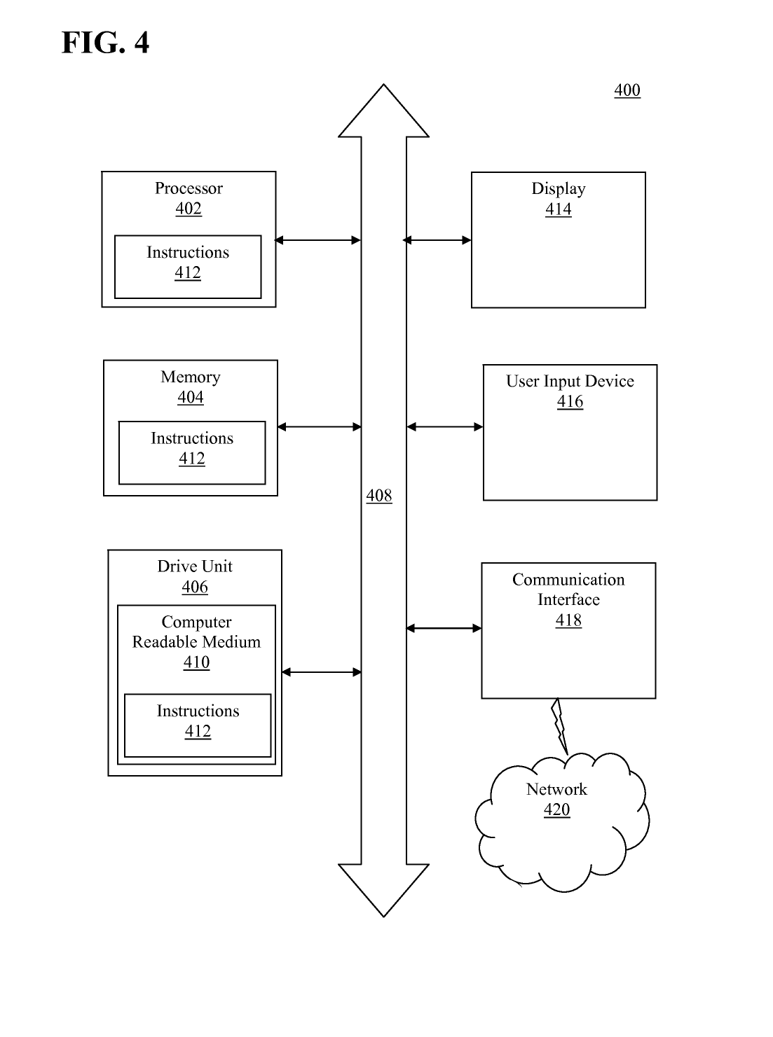

The exchange computer system 100 may be implemented with one or more mainframe, desktop or other computers, such as the computer 400 described below with respect to FIG. 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by the order book module 110 and/or match engine module 106. A volume control module 140 may be included to, among other things, control the rate of acceptance of mass quote messages.

The trading network environment shown in FIG. 1 includes exemplary computer devices 114, 116, 118, 120 and 122 which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As was described above, the users of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

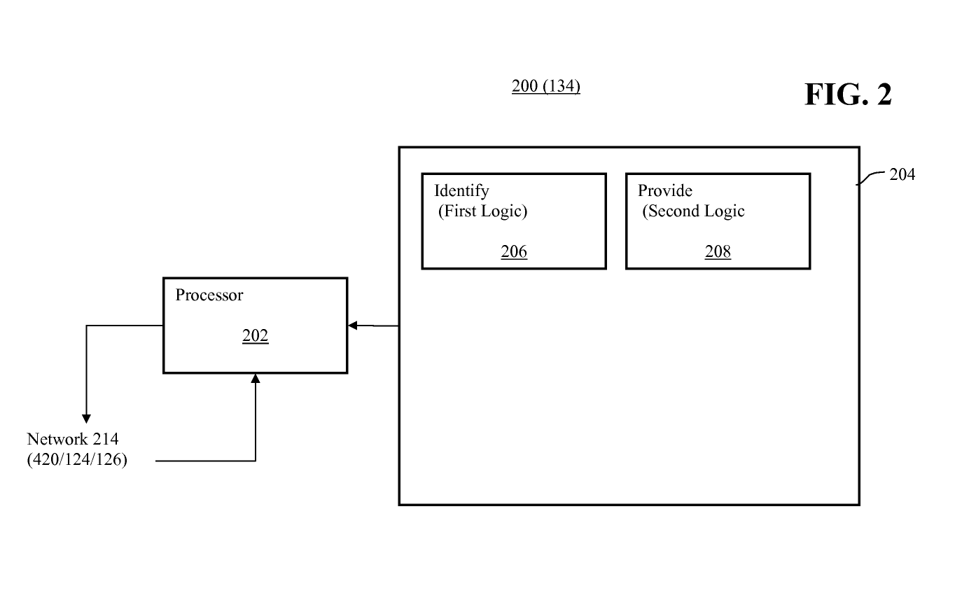

As shown in FIG. 1, the Exchange computer system 100 further includes a risk management module 134 which may implement the disclosed mechanisms as will be described with reference to FIG. 2. It will be appreciated the disclosed embodiments may be implemented as a separate module or a separate computer system coupled with the Exchange computer system 100 so as to have access to the requisite portfolio data. As described above, the disclosed embodiments may be implemented as a centrally accessible system or as a distributed system where some of the disclosed functions are performed by the computer systems of the market participants.

FIG. 2 depicts a block diagram of a risk management module 134 according to one embodiment, which in an exemplary implementation, is implemented as part of the exchange computer system 100 described above. As used herein, an exchange 100 includes a place or system that receives and/or executes orders.

In particular, FIG. 2 shows a system 200, which may implement the trade searching engine and trade filtering engine described above, for minimizing risk of loss, i.e. price sensitivity also referred to as “DV01”, and thereby, an initial margin requirement, maintenance margin requirement and/or guaranty fund contribution requirement correlated thereto/computed therefore, for a portfolio held by a market participant, such as a clearing member of a clearing organization, the portfolio comprising a plurality of interest rate swap (“IRS”) positions. The system 200 may be used, as described, to analyze all portfolios of all market participants, or a subset thereof. In one embodiment, the system 200 is used to analyze all, or a subset of, production portfolios of all, or a subset, of the clearing members of a clearing organization, such as CME clearing. The system 200 may not reveal the identities of the market participants to each other.

The system 200 includes a processor 202 and a memory 204 coupled therewith which may be implemented a processor 402 and memory 404 as described below with respect to FIG. 4. The system 200 further includes first logic 206 stored in the memory 204 and executable by the processor 202 to cause the processor 202 identify, for each of one or more of the plurality of IRS positions, a counter-position in another portfolio held by another market participant, which may not be readily ascertainable by the market participant for a proposed trade therewith wherein execution of the proposed trade would result in a reduction of the risk of loss of the portfolio, and, in one embodiment, the other portfolio. It will be appreciated that the counter positions for each position in the portfolio need not be identified in the same other portfolio and that counter positions may be identified in one or more other portfolios.

The system 200 further include second logic 208 stored in the memory 204 and executable by the processor 202 to cause the processor 202 to provide each of the identified proposed trades to the market participant, and, in one embodiment, the other market participant holding the counter position thereto, for acceptance. Neither the market participant nor the other market participant holding the counter position may know the identity of each other due to the operation of the central clearing organization as a central counterparty to the transaction.

In one embodiment, the second logic 208 may be further operative to cause the processor 202 to receive acceptance of the one or more proposed trades from the market participant(s) and, based thereon, cause the one or more proposed trades to be executed, such as by the Exchange computer system 100 described above, wherein the risk of loss for the portfolio is reduced thereby. In one embodiment, the identified one or more proposed trades may be provided to the market participant(s) in a format, such as the FIX format, suitable for submission to the Exchange, i.e. the Exchange computer system 100, wherein the market participant(s) may simply accept the trades or otherwise forward the trades to the Exchange to easily cause the execution thereof.

In one embodiment, the first logic 206 may be further operative to cause the processor 202 to identify, for each of the plurality of IRS positions, a counter-position in another portfolio held by another market participant for a proposed trade therewith wherein execution of the proposed trade would result in a reduction of the risk of loss of the portfolio in excess of a threshold amount. In this way, only those trades which cause a reduction which exceeds the threshold are proposed to the market participant. This may act to reduce the number of proposed trades and eliminate those trades which would result only in an insignificant reduction in the risk of loss. In one exemplary implementation, the threshold amount for which the risk of loss must be reduced is $10 million dollars. It will be appreciated that any threshold may be utilized, including zero, and that the threshold value is implementation dependent.

In one embodiment, the first logic 206 may be further operative to cause the processor 202 to calculate an initial risk of loss of the portfolio, and a margin requirement corresponding to the calculated initial risk of loss, identify an initial plurality of candidate proposed trades, each being associated with an initial price sensitivity, each being characterized by payer side and a receiver side, and determine, such as based on an optimal hedge ratio (which minimizes variance), for each of the initial plurality of candidate proposed trades, an IRS position in the portfolio corresponding to one of the payer side or receiver side of the particular candidate proposed trade, and a counter IRS position in another portfolio corresponding to the other of the payer side or receiver side of the candidate proposed trade, and based thereon, calculating a modified risk of loss of the portfolio based on execution of the particular candidate proposed trade, and a modified margin requirement corresponding thereto.

The initial risk of loss and modified risk of loss may be computed based on a change in net present value for each of the plurality of IRS positions for a one basis point change at each of a plurality of tenor points along a rate curve therefore. The margin requirement corresponding to the calculated risk of loss may be calculated based on a plurality of profit and loss scenarios for the portfolio as a function of potential loss in value thereof over a defined period of time for a defined confidence interval. The initial plurality of candidate proposed trades may include proposed trades for each of a plurality of currencies, such as, but not limited to, US dollars, Canadian dollars, Australian dollars, Euros, Swiss Francs, Great Britain pounds, or Japanese yen.

In one embodiment, the first logic 206 may be further operative to cause the processor 202 to determine, for each candidate proposed trade wherein the modified margin requirement is less than the initial margin requirement, a swap margin requirement based on a net present value of floating and fixed cash flows, and identify a proposed trade as a candidate proposed trade for which a difference between the initial margin requirement and the swap margin requirement exceeds a threshold. In one embodiment, the first logic 206 may implement the trade filtering engine described above.

In one embodiment, the system 200 for minimizing risk of loss for a portfolio held by a market participant, the portfolio comprising a plurality of interest rate swap (“IRS”) positions, may include a processor 202 and a non-transitory memory 204 coupled therewith, such as the memory 404 described below with respect to FIG. 4, the memory 204 having stored therein computer program logic 206, 208 executable by the processor 202 to cause the processor 202 to identify, for each of one or more of the plurality of IRS positions, a counter-position in another portfolio held by another market participant, and not accessible or ascertainable by the market participant, for a proposed trade therewith wherein execution of the proposed trade would result in a reduction of the risk of loss of the portfolio and the other portfolio, by causing the processor 202 to iteratively test each of a set of candidate trades between substantially equivalent positions in the portfolio and other portfolio for an effect on the risk of loss of the portfolio, the identified proposed trade comprising a candidate trade which results in a reduction in risk of loss of the portfolio in excess of a threshold; and wherein the computer program logic 206 208 is further executable by the processor 202 to cause the processor 202 to provide each of the identified proposed trades to at least the market participant for acceptance wherein neither the market participant or the other market participant of each proposed trade know the identity of each other.

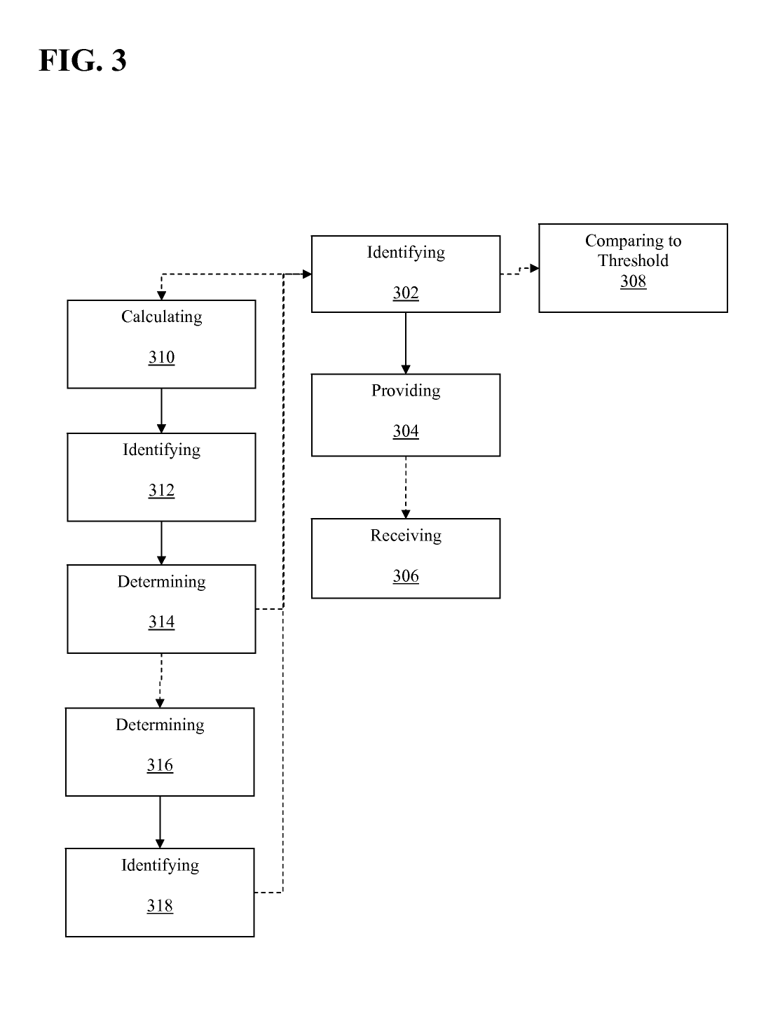

FIG. 3 depicts a flow chart showing operation of the system 200 of FIG. 2. In particular FIG. 3 shows a computer implemented method for minimizing risk of loss, i.e. the price sensitivity or DV01, and thereby, an initial margin requirement, maintenance margin requirement, and/or guaranty fund contribution amount correlated thereto/computed therefore, for a portfolio held by a market participant, the portfolio comprising a plurality of interest rate swap (“IRS”) positions. As described above, the system 200 may be used, as described, to analyze all portfolios of all market participants, or a subset thereof. In one embodiment, the system 200 is used to analyze all, or a subset of, production portfolios of all, or a subset, of the clearing members of a clearing organization, such as CME clearing. The system 200 may not reveal the identities of the market participants to each other.

The operation includes: identifying, by a processor 202 for each of one or more of the plurality of IRS positions, a counter-position in another portfolio, which may be different for each position, held by another market participant, which may not be available to/accessible and/or ascertainable by the market participant, for a proposed trade therewith wherein execution of the proposed trade would result in a reduction of the risk of loss of the portfolio and, in one embodiment, the other portfolio (Block 302); and providing, by the processor 202, each of the identified proposed trades to the market participant(s) for acceptance and wherein neither the market participant or the other market participant of each proposed trade may know the identity of each other (Block 304).

In one embodiment, the operation of the system 200 may further include receiving, by the processor 202, acceptance of the one or more proposed trades from the market participant and, based thereon, causing the one or more proposed trades to be executed, wherein the risk for the portfolio is reduced thereby (Block 306). In one embodiment, the one or more proposed trades are formatted for submission to an Exchange, such as the Exchange computer system 100 described above, to cause execution thereof.

In one embodiment, the identifying further includes identifying, by the processor 202 for each of the plurality of IRS positions, a counter-position in another portfolio held by another market participant for a proposed trade therewith wherein execution of the proposed trade would result in a reduction of the risk of loss of the portfolio in excess of a threshold amount (Block 308), e.g. $10 million dollars.

In one embodiment, the operation of the system 200 to identify candidate proposed trades further includes: calculating, by the processor, an initial risk of loss of the portfolio, and a margin requirement corresponding to the calculated initial risk of loss (Block 310); Identifying an initial plurality of candidate proposed trades, each being associated with an initial price sensitivity, each being characterized by payer side and a receiver side (Block 312); and determining, by the processor, for each of the initial plurality of candidate proposed trades, an IRS position in the portfolio corresponding to one of the payer side or receiver side of the particular candidate proposed trade, and a counter IRS position in another portfolio corresponding to the other of the payer side or receiver side of the candidate proposed trade, and based thereon, calculating a modified risk of loss of the portfolio based on execution of the particular candidate proposed trade, and a modified margin requirement corresponding thereto (Block 314).

In one embodiment, the initial risk of loss and modified risk of loss are computed based on a change in net present value for each of the plurality of IRS positions for a one basis point change at each of a plurality of tenor points along a rate curve therefore. In one embodiment, the margin requirement corresponding to the calculated risk of loss is calculated based on a plurality of profit and loss scenarios for the portfolio as a function of potential loss in value thereof over a defined period of time for a defined confidence interval. In one embodiment, the initial plurality of candidate proposed trades include proposed trades for each of a plurality of currencies, such as, but not limited to, US Dollars, Canadian Dollars, Australian Dollars, Euros, Swiss Francs, Great Britain pounds and/or Japanese yen. In one embodiment, the determining of the IRS position and the counter IRS position is based on the an optimal hedge ration therebetween.

In one embodiment, the operation of the system 200 further includes: determining, by the processor for each candidate proposed trade wherein the modified margin requirement is less than the initial margin requirement, a swap margin requirement based on a net present value of floating and fixed cash flows (Block 316); and identifying, by the processor, a proposed trader as a candidate proposed trade for which a difference between the initial margin requirement and the swap margin requirement exceeds a threshold (Block 318).

In one embodiment, the identifying is performed for each of a plurality of portfolios.

One skilled in the art will appreciate that one or more modules described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an exchange 100 for financial instruments.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method of minimizing risk of loss for a portfolio held by a market participant, the portfolio comprising a plurality of interest rate swap (“IRS”) positions, the method comprising:
identifying, by a processor for each of one or more of the plurality of IRS positions, a counter-position in another portfolio held by another market participant for a proposed trade therewith wherein execution of the proposed trade would result in a reduction of the risk of loss of the portfolio; and
providing, by the processor, each of the identified proposed trades to the market participant for acceptance.

2. The computer implemented method of claim 1 wherein the market participant comprises a clearing member and the portfolio comprises a production portfolio thereof.

3. The computer implemented method of claim 1 further comprising correlating the risk of loss to a margin requirement amount for the portfolio.

4. The computer implemented method of claim 1 wherein the risk of loss comprises a measure of price sensitivity (“DV01”) of the portfolio.

5. The computer implemented method of claim 1 further comprising correlating, by the processor, the risk of loss to a guarantee fund contribution amount.

6. The computer implemented method of claim 1 further comprising receiving, by the processor, acceptance of the one or more proposed trades from the market participant and, based thereon, causing the one or more proposed trades to be executed, wherein the risk of loss for the portfolio is reduced thereby.

7. The computer implemented method of claim 1 wherein the one or more proposed trades are formatted for submission to an Exchange to cause execution thereof.

8. The computer implemented method of claim 1 wherein the identifying further comprises identifying, by the processor for each of the plurality of IRS positions, a counter-position in another portfolio held by another market participant for a proposed trade therewith wherein execution of the proposed trade would result in a reduction of the risk of loss of the portfolio in excess of a threshold amount.

9. The computer implemented method of claim 1 wherein the identifying further comprises:
calculating, by the processor, an initial risk of loss of the portfolio, and a margin requirement corresponding to the calculated initial risk of loss;
Identifying an initial plurality of candidate proposed trades, each being associated with an initial price sensitivity, each being characterized by payer side and a receiver side; and
determining, by the processor, for each of the initial plurality of candidate proposed trades, an IRS position in the portfolio corresponding to one of the payer side or receiver side of the particular candidate proposed trade, and a counter IRS position in another portfolio corresponding to the other of the payer side or receiver side of the candidate proposed trade, and based thereon, calculating a modified risk of loss of the portfolio based on execution of the particular candidate proposed trade, and a modified margin requirement corresponding thereto.

10. The computer implemented method of claim 9 wherein the initial risk of loss and modified risk of loss are computed based on a change in net present value for each of the plurality of IRS positions for a one basis point change at each of a plurality of tenor points along a rate curve therefore.

11. The computer implemented method of claim 9 wherein the margin requirement corresponding to the calculated risk of loss is calculated based on a plurality of profit and loss scenarios for the portfolio as a function of potential loss in value thereof over a defined period of time for a defined confidence interval.

12. The computer implemented method of claim 9 wherein the initial plurality of candidate proposed trades include proposed trades for each of a plurality of currencies.

13. The computer implemented method of claim 9 wherein the determining of the IRS position and the counter IRS position is based on the an optimal hedge ration therebetween.

14. The computer implemented method of claim 9 further comprising:
determining, by the processor for each candidate proposed trade wherein the modified margin requirement is less than the initial margin requirement, a swap margin requirement based on a net present value of floating and fixed cash flows; and
identifying, by the processor, a proposed trade as a candidate proposed trade for which a difference between the initial margin requirement and the swap margin requirement exceeds a threshold.

15. The computer implemented method of claim 9 wherein the identifying is performed for each of a plurality of portfolios.

16. A system for minimizing risk of loss for a portfolio held by a market participant, the portfolio comprising a plurality of interest rate swap (“IRS”) positions, the system comprising:
first logic stored in a memory and executable by a processor coupled therewith to cause the processor to identify, for each of one or more of the plurality of IRS positions, a counter-position in another portfolio held by another market participant for a proposed trade therewith wherein execution of the proposed trade would result in a reduction of the risk of loss of the portfolio; and
second logic stored in the memory and executable by the processor to cause the processor to provide each of the identified proposed trades to the market participant for acceptance.

17. The system of claim 16 wherein the market participant comprises a clearing member and the portfolio comprises a production portfolio thereof.

18. The system of claim 16 wherein the first logic is further operative to cause the processor to correlate the risk of loss to a margin requirement amount for the portfolio.

19. The system of claim 16 wherein the risk of loss comprises a measure of price sensitivity (“DV01”) of the portfolio.

20. The system of claim 16 wherein the first logic is further operative to cause the processor to correlate the risk of loss to a guarantee fund contribution amount.

21. The system of claim 16 wherein the second logic is further operative to cause the processor to receive acceptance of the one or more proposed trades from the market participant and, based thereon, cause the one or more proposed trades to be executed, wherein the risk of loss for the portfolio is reduced thereby.

22. The system of claim 16 wherein the one or more proposed trades are formatted for submission to an Exchange to cause execution thereof.

23. The system of claim 16 wherein the first logic is further operative to cause the processor to identify, for each of the plurality of IRS positions, a counter-position in another portfolio held by another market participant for a proposed trade therewith wherein execution of the proposed trade would result in a reduction of the risk of loss of the portfolio in excess of a threshold amount.

24. The system of claim 16 wherein the first logic is further operative to cause the processor to calculate an initial risk of loss of the portfolio, and a margin requirement corresponding to the calculated initial risk of loss, identify an initial plurality of candidate proposed trades, each being associated with an initial price sensitivity, each being characterized by payer side and a receiver side, and determine, for each of the initial plurality of candidate proposed trades, an IRS position in the portfolio corresponding to one of the payer side or receiver side of the particular candidate proposed trade, and a counter IRS position in another portfolio corresponding to the other of the payer side or receiver side of the candidate proposed trade, and based thereon, calculating a modified risk of loss of the portfolio based on execution of the particular candidate proposed trade, and a modified margin requirement corresponding thereto.

25. The system of claim 24 wherein the initial risk of loss and modified risk of loss are computed based on a change in net present value for each of the plurality of IRS positions for a one basis point change at each of a plurality of tenor points along a rate curve therefore.

26. The system of claim 24 wherein the margin requirement corresponding to the calculated risk of loss is calculated based on a plurality of profit and loss scenarios for the portfolio as a function of potential loss in value thereof over a defined period of time for a defined confidence interval.

27. The system of claim 24 wherein the initial plurality of candidate proposed trades include proposed trades for each of a plurality of currencies.

28. The system of claim 24 wherein the determining of the IRS position and the counter IRS position is based on the an optimal hedge ration therebetween.

29. The system of claim 24 wherein the first logic is further operative to cause the processor to determine, for each candidate proposed trade wherein the modified margin requirement is less than the initial margin requirement, a swap margin requirement based on a net present value of floating and fixed cash flows, and identify a proposed trade as a candidate proposed trade for which a difference between the initial margin requirement and the swap margin requirement exceeds a threshold.

30. The system of claim 24 wherein the identifying is performed for each of a plurality of portfolios.

31. A system for minimizing risk of loss for a portfolio held by a market participant, the portfolio comprising a plurality of interest rate swap (“IRS”) positions, the method comprising:
means for identifying, for each of the plurality of IRS positions, a counter-position in another portfolio held by another market participant for a proposed trade therewith wherein execution of the proposed trade would result in a reduction of the risk of loss of the portfolio; and
means for providing each of the identified proposed trades to the market participant for acceptance.

32. A system for minimizing risk of loss for a portfolio held by a market participant, the portfolio comprising a plurality of interest rate swap (“IRS”) positions, the system comprising:
a processor and a non-transitory memory coupled therewith, the memory having stored therein computer program logic executable by the processor to cause the processor to identify, for each of one or more of the plurality of IRS positions, a counter-position in another portfolio held by another market participant, and not accessible by the market participant, for a proposed trade therewith wherein execution of the proposed trade would result in a reduction of the risk of loss of the portfolio and the other portfolio, by causing the processor to iteratively test each of a set of candidate trades between substantially equivalent positions in the portfolio and other portfolio for an effect on the risk of loss of the portfolio, the identified proposed trade comprising a candidate trade which results in a reduction in risk of loss of the portfolio in excess of a threshold; and
wherein the computer program logic is further executable by the processor to cause the processor to provide each of the identified proposed trades to at least the market participant for acceptance wherein neither the market participant or the other market participant of each proposed trade know the identity of each other.
